(19) United States
(12) Patent Application Publication
(10) Pub. No.: US 2026/0291772 A1
(43) Pub. Date: Sep. 24, 2026

(54) NETWORK SYSTEM FOR A TRACTOR UNIT OF A MULTI-PART VEHICLE, TRACTOR UNIT, METHOD, COMPUTER PROGRAM AND/OR COMPUTER-READABLE MEDIUM

(71) Applicant: ZF CV Systems Global GmbH, Bern (CH)

(72) Inventor: Thomas Dieckmann, Pattensen (DE)

(21) Appl. No.: 19/684,970

(22) Filed: May 21, 2026

Related U.S. Application Data
(63) Continuation of application No. PCT/EP2024/080516, filed on Oct. 29, 2024.

(30) Foreign Application Priority Data
Nov. 27, 2023 (DE) 10 2023 132 940.5

(51) Int. Cl. H04L 12/40; H04L 12/46

(52) U.S. Cl. CPC H04L 12/40032; H04L 12/40169; H04L 12/46; H04L 2012/40273

(57) ABSTRACT

A network system is for a tractor unit of a multi-part vehicle, in particular a utility vehicle, including the tractor unit and a trailer vehicle. The network system has a tractor-unit-installed first data processing device which has a plurality of network interfaces for communicatively connecting the first data processing device to one other data processing device each. The network system is configured to assign each of the other data processing devices a zone and/or domain of the vehicle according to the network interface via which the particular other data processing device is and/or can be communicatively connected to the first data processing device. One of the network interfaces is connected and/or able to be connected to a trailer-installed second data processing device. The network system is configured to assign the second data processing device a trailer-specific zone and/or trailer-specific domain.

### CROSS-REFERENCE TO RELATED APPLICATIONS

This application is a continuation application of international patent application PCT/EP2024/080516, filed Oct. 29, 2024, designating the United States and claiming priority from German application 10 2023 132 940.5, filed Nov. 27, 2023, and the entire content of both applications is incorporated herein by reference.

### TECHNICAL FIELD

The disclosure relates to a network system for a tractor vehicle of a multi-unit vehicle, in particular utility vehicle, having the tractor vehicle and a trailer vehicle. The disclosure also relates to a tractor vehicle of a multi-unit vehicle, in particular utility vehicle, including a network system, to a method for establishing a network system, and to a computer program and/or computer-readable medium.

### BACKGROUND

Network systems for vehicles are known from the prior art. It is known that network systems of single-unit vehicles, for example passenger cars and/or tractor vehicles, have a domain and/or zone architecture. A domain architecture can for example define a functional organization of the components of the network system in domains. The domains thus include components organized by function. A zone architecture can for example define a spatial organization of the components of the network system in zones. The zones thus include spatially organized components. Through appropriate configuration of the network system by organization in zones and/or domains, it is possible to improve the performance of the network system with regard to the communication between the components connected by the network system, and/or to reduce the outlay required to provide wiring for the network system.

In the case of multi-unit vehicles, that is, tractor vehicle-trailer vehicle combinations, the possibility of detaching the tractor vehicle and the trailer vehicle from one another and, if necessary, exchanging and attaching one of the vehicles gives rise to further degrees of freedom, which must be taken into account when configuring a network system.

For example, a tractor vehicle and a trailer vehicle can be communicatively interconnected via an interface, a so-called “truck-trailer link” or TT link. Such a connection is necessary, for example, for transmitting image data and/or other sensor data from the trailer vehicle to the tractor vehicle and/or for controlling functions of the trailer vehicle.

The communicative connection of the tractor vehicle and the trailer vehicle is known from the prior art. Different transmission paths may be provided.

DE 10 2016 010 644 A1 discloses a method for establishing a wireless vehicle network having at least one first station in a tractor vehicle and a second station in a trailer, wherein the first station sends the information necessary for establishing the wireless network, and, via a physical interface between tractor vehicle and trailer, a first controller assigned to the first station receives a defined message from a second controller assigned to the second station, after the second controller has been supplied with electrical power and the two controllers have been interconnected via the physical interface. According to the disclosure, the first station wirelessly sends the information required for establishing the wireless network only when the defined message has arrived at the first station.

DE 10 2017 010 356 A1 discloses a data system of a tractor vehicle and/or trailer vehicle.

US 2019/217831 A1 discloses a vehicle system including a front vehicle and a rear vehicle that is towed by the front vehicle. The front vehicle and the rear vehicle together have a control subsystem for controlling, inter alia, the braking of the rear vehicle. The control subsystem includes a front unit in the front vehicle and a rear unit in the rear vehicle. The rear unit may be configured to serve as a gateway for other rear-vehicle devices and other rear vehicles. A cable establishes an operative connection between a front connector of the front vehicle and a rear controller of the rear unit of the rear vehicle.

Further possible specific features with reference to a tractor vehicle-trailer vehicle combination, in particular a configuration of a domain and/or zone architecture, are not known in the prior art.

### SUMMARY

It is an object of the present disclosure to specify a network system which is suitable for enhancing the prior art. In particular, it is the object of the disclosure to provide an effective and well-defined network architecture for the use case of a multi-unit vehicle. This object is achieved by various embodiments.

According to a first aspect of the disclosure, the object is achieved via a network system for a tractor vehicle of a multi-unit vehicle, in particular utility vehicle, having the tractor vehicle and a trailer vehicle, wherein the network system has a tractor-vehicle-side first data processing device, the first data processing device has a plurality of network interfaces for communicatively connecting the first data processing device to one further data processing device each, the network system is configured to assign a zone and/or domain of the vehicle, in particular utility vehicle, to each of the further data processing devices in accordance with the network interface by which the particular further data processing device is communicatively connected and/or connectable to the first data processing device, wherein one of the network interfaces is connected and/or connectable to a trailer-side second data processing device, and the network system is configured to assign a trailer-specific zone and/or trailer-specific domain to the second data processing device.

In other words, the disclosure relates to a domain and/or zone architecture for a multi-unit vehicle. The domain and/or zone architecture can be replicated by the network system. The first data processing device, as a component of the network, may be a central controller for operating the network and referred to as a so-called “service-oriented gateway”. The first data processing device is connected and/or connectable via the network interfaces to one or more further data processing devices as network components. The further data processing devices may be assigned to domains in accordance with their function and/or to zones in accordance with their physical arrangement.

The trailer vehicle has the second data processing device. The second data processing device is thus arranged physically outside the tractor vehicle. The second data processing device and the first data processing device can thus, like the trailer vehicle, be detached or separated from, and attached or connected to, the tractor vehicle. In order that the second data processing device can nevertheless be logically integrated into the network system of the tractor vehicle, it is proposed that one of the network interfaces is a trailer-specific network interface, via which the first data processing device can be connected to the second data processing device. In this case, the trailer-specific zone and/or trailer-specific domain can be assigned to the second data processing device.

In other words, a network system for a tractor vehicle is provided which has interconnected data processing devices having a domain and/or zone architecture, wherein one of the data processing devices, namely the second trailer-side data processing device, is arranged physically outside the tractor vehicle, namely in the trailer vehicle. A well-known domain and/or zone architecture is thus expanded such that physically outlying network components can be logically integrated into the network system.

Thus, the trailer vehicle or its second data processing device can be incorporated into the network architecture of the tractor vehicle and assigned to a domain and/or zone, in order to provide an effective and well-defined network architecture for the use case of a multi-unit vehicle.

According to various embodiments, the trailer-specific zone and/or trailer-specific domain is assignable to the second data processing device on the basis of the connection via a trailer-specific network interface. It has been recognized here that network interfaces may include a trailer-specific network interface. The connection of the second data processing device and the first data processing device via the trailer-specific network interface enables the second data processing device to be identified as being trailer-specific, allowing reliable and well-defined assignment of the trailer-specific zone and/or trailer-specific domain.

According to various embodiments, each of the network interfaces is an Automotive Ethernet interface. The components of the network system can be connected efficiently via the Automotive Ethernet interface. Via the Automotive Ethernet interface, the first data processing device can be connected effectively to the further data processing devices and/or to the second data processing device, and reliable and effective data transmission can be achieved.

According to various embodiments, the network system has a tractor vehicle-trailer vehicle interface, which is connected to a trailer-specific network interface, for communicatively connecting the first data processing device and the second data processing device. In this case, the tractor vehicle-trailer vehicle interface may be an interface arranged, for example, in a rear region of the tractor vehicle, in order to be able to effectively establish a reliable communicative connection when the trailer vehicle is attached to the tractor vehicle.

According to various embodiments, each of the network interfaces is configured for wired communicative connection. It has been recognized here that wired communication is particularly reliable and allows a sufficient range or cable length for a multi-unit vehicle, in particular utility vehicle.

According to various embodiments, the trailer-specific zone differs from each of the zones and/or the trailer-specific domain differs from each of the domains. In other words, the trailer-specific zone is different from other zones of the tractor vehicle, and/or the trailer-specific domain is different from other domains of the tractor vehicle. This allows targeted communication with the network components of the trailer vehicle.

According to various embodiments, the network system is configured to assign a plurality of trailer-specific zones and/or trailer-specific domains to trailer-side further data processing devices. It has been recognized here that the trailer vehicle may also have a plurality of data processing devices or network components. Organization of the network components in a plurality of trailer-specific zones and/or trailer-specific domains may therefore be advisable.

According to an aspect of the disclosure, a tractor vehicle of a multi-unit vehicle, in particular utility vehicle, including the above-described network system is provided. According to various embodiments, the vehicle, in particular utility vehicle, and/or the network system has one or more of the features described above as being optional and/or advantageous, in order to achieve an associated technical effect.

According to an aspect of the disclosure, a method for establishing an above-described network system is provided, wherein the method includes: detecting a connection of the second data processing device and the first data processing device by the trailer-specific network interface; assigning the trailer-specific zone and/or the trailer-specific domain to the second data processing device; and outputting and/or storing an assignment information item corresponding to the assignment. According to various embodiments, the method is implemented such that the network system has one or more of the features described above as being optional and/or advantageous, in order to achieve an associated technical effect.

According to an aspect of the disclosure, a computer program and/or a computer-readable medium is provided. The computer program and/or the computer-readable medium includes/include commands which, when the program or the commands is or are executed by a data processing device, cause the latter to carry out the method according to the disclosure and/or steps of the method. According to various embodiments, the computer program and/or the computer-readable medium includes/include commands which, when the program or the commands is or are executed by a data processing device, cause the latter to carry out the method steps described as being advantageous or optional, in order to achieve an associated technical effect.

### BRIEF DESCRIPTION OF DRAWINGS

The invention will now be described with reference to the drawings wherein:

FIG. 1 schematically shows a multi-unit vehicle, in particular utility vehicle, having a tractor vehicle that has a network system according to an aspect of the disclosure;

FIG. 2 schematically shows a multi-unit vehicle, in particular utility vehicle, having a tractor vehicle that has a network system according to another aspect of the disclosure;

FIG. 3 schematically shows a flow diagram of a method according to an aspect of the disclosure; and,

FIG. 4 is a schematic illustration of a computer program and/or computer-readable medium according to an aspect of the disclosure.

### DETAILED DESCRIPTION

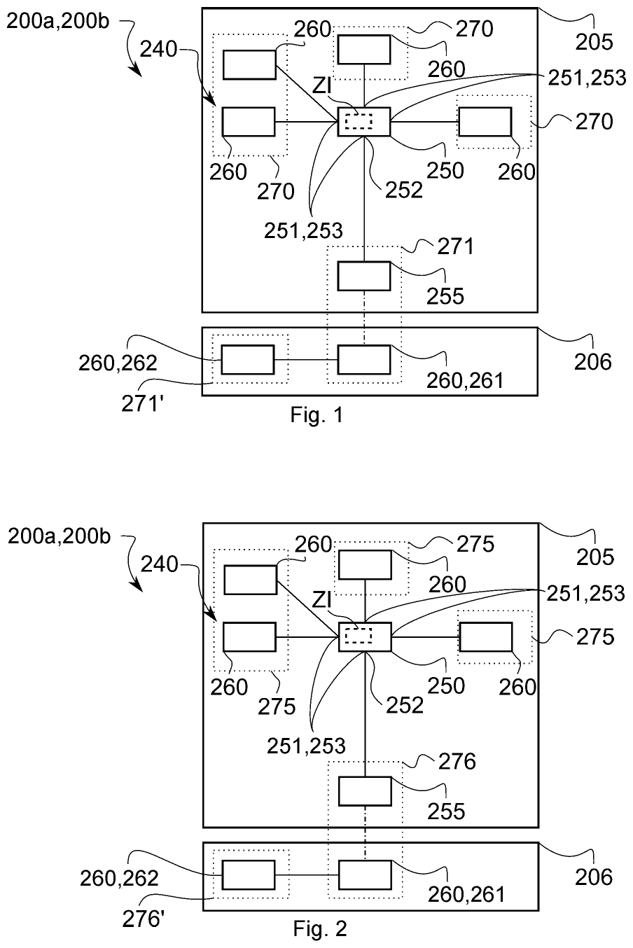

FIG. 1 schematically shows a multi-unit vehicle 200a, in particular utility vehicle 200b, having a tractor vehicle 205 that has a network system 240 according to an aspect of the disclosure.

The multi-unit vehicle 200a, in particular utility vehicle 200b, is referred to below as vehicle 200a, 200b. The vehicle 200a, 200b is a land vehicle. The vehicle 200a, 200b includes the tractor vehicle 205 and a trailer vehicle 206. The vehicle 200a, 200b is thus a two-unit vehicle 200a, 200b. In another embodiment (not shown), the vehicle 200a, 200b may have more than two units, for example a plurality of trailer vehicles 206.

The tractor vehicle 205 and the trailer vehicle 206 can be mechanically interconnected in order that the tractor vehicle 205 can move the trailer vehicle 206. For data exchange between the tractor vehicle 205 and the trailer vehicle 206, the tractor vehicle 205 and the trailer vehicle 206 are configured to be communicatively interconnected. The tractor vehicle 205 has a tractor vehicle-trailer vehicle interface 255 for this purpose. The tractor vehicle-trailer vehicle interface 255 thus physically makes possible the electrical and communicative connection of the tractor vehicle 205 to the trailer vehicle 206. For this purpose, the tractor vehicle-trailer vehicle interface 255 is configured as a plug-type connection. In this case, the tractor vehicle-trailer vehicle interface 255 may be configured for example as a socket, and the trailer vehicle 206 may have a plug corresponding to the socket, or vice versa.

The trailer vehicle 205 has a network system 240. The network system 240 forms a set of communicatively connectable and/or connected network components.

The network system 240 includes a tractor vehicle-side first data processing device 250 as one network component. The first data processing device 250 is arranged in and/or on the tractor vehicle 205. The first data processing device 250 is a network component which is configured, for example, for managing the network system 240. For this purpose, the first data processing device 250 has a plurality of network interfaces 251, 252 for communicatively connecting the first data processing device 250 to one further data processing device 260, 261 each.

The further data processing devices 260, 261 may for example include control devices, actuators and/or sensors, which are integrated and/or integrable as network components into the network system 240.

The network system 240 is configured to assign a zone 270 of the vehicle 200a, 200b to each of the further data processing devices 260, 261 in accordance with the network interface 251, 252 by which the particular further data processing device 260, 261 is communicatively connected and/or connectable to the first data processing device 250. The zones 270 are local sections of the vehicle 200a, 200b. The further data processing devices 260, 261 within a zone 270 are thus arranged in the same section of the vehicle 200a, 200b, for example at the front, on the left or on the right as seen in the direction of travel. One or more of the further data-processing devices 260, 261 may be assigned to each of the zones 270. In this case, each of the further data processing devices 260, 261 may be assigned to exactly one of the zones 270.

One of the network interfaces 251, 252 is connected and/or connectable to a trailer-side second data processing device 261. The trailer vehicle 206 thus includes the second data processing device 261. The second data processing device 261 is thus arranged physically in and/or on the trailer vehicle 206. The second data processing device 261 is configured to control and/or monitor components of the trailer vehicle 206. The second data processing device 261 may in particular control and/or monitor, for example, lights, brakes, components of an electrically drivable trailer vehicle 206, automated driving functions and/or sensors of the trailer vehicle 206.

The network system 240 is configured to assign a trailer-specific zone 271 to the second data processing device 261. The second data processing device 261 is thus integrated into the network system 240. The trailer-specific zone 271 differs from each of the zones 270.

One of the network interfaces 251, 252 is a trailer-specific network interface 252. The trailer-specific network interface 252 is communicatively connected to the tractor vehicle-trailer vehicle interface 255. The trailer-specific network interface 252 is configured similarly to the other network interfaces 251 and does not differ from the other network interfaces 251, aside from the connection to the tractor vehicle-trailer vehicle interface 255. Connecting the second data processing device 261 to the tractor vehicle-trailer vehicle interface 255 thus indirectly creates a communicative connection between the first data processing device 250 and the second data processing device 261 via the trailer-specific network interface 252. The trailer-specific zone 271 is assignable to the second data processing device 261 on the basis of the connection via a trailer-specific network interface 252. Upon the assignment of the second data processing device 261 to the trailer-specific zone 271, an assignment information item ZI is created which represents the assignment, the assignment information item being written into a data memory (not shown) of the first data processing device 250. Alternatively or in addition, the assignment information item ZI is output for further processing.

Each of the network interfaces 251, 252 is an Automotive Ethernet interface 253. Each of the network interfaces 251, 252 is configured for wired communicative connection.

The network system 240 is configured to assign a plurality of trailer-specific zones 271, 271′ to trailer-side further data processing devices 262. The trailer vehicle 206 in the example shown in FIG. 1 has a trailer-side further data processing device 262. The trailer-side further data processing device 262 is formed, and communicatively connected to the second data processing device 261, via a network interface similar to the network interfaces 251, 252, 253 of the tractor vehicle 205. A trailer-specific zone 271 is also assigned to the trailer-side further data processing device 262, whereby the network system 240 assigns a plurality of zones 271, 271′ to the trailer vehicle 206. In another embodiment (not shown), the trailer vehicle 206 may have a plurality of trailer-side further data processing devices 262, to which a corresponding number of zones 271′ can be assigned.

FIG. 2 schematically shows a multi-unit vehicle 200a, in particular utility vehicle 200b, having a tractor vehicle 205 that has a network system 240 according to an aspect of the disclosure. FIG. 2 shows an alternative to FIG. 1. FIG. 2 is described with reference to FIG. 1, wherein the differences between FIGS. 1 and 2 are described.

According to FIG. 2, the further data processing device 260, 261 is assigned in accordance with domains 275. The network system 240 is thus configured to assign a domain 275 of the vehicle 200a, 200b to each of the further data processing devices 260, 261 in accordance with the network interface 251, 252 by which the particular further data processing device 260, 261 is communicatively connected and/or connectable to the first data processing device 250.

The domains 275 are organized on a functional basis. The further data processing devices 260, 261 within a domain 275 are thus assigned, for example, to one of the functional groups “drive system”, “chassis”, “infotainment system”, “autonomous driving function”, et cetera. One or more of the further data-processing devices 260, 261 may be assigned to each of the domains 275. In this case, each of the further data processing devices 260, 261 may be assigned to exactly one of the domains 275.

The network system 240 is configured to assign a trailer-specific domain 276 to the second data processing device 261. The assignment of the trailer-specific domain 276 is as described with regard to FIG. 1 with reference to the trailer-specific zone 271. In this case, the trailer-specific domain 276 according to FIG. 2 differs from each of the domains 275. The network system 240 is configured to assign a plurality of trailer-specific domains 276, 276′ to trailer-side further data processing devices 262.

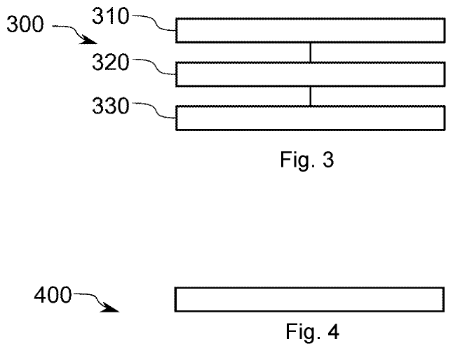

FIG. 3 schematically shows a flow diagram of a method 300 according to an aspect of the disclosure. The method 300 according to FIG. 3 is a method 300 for establishing a network system 250. A network system 240 of this kind is described with reference to FIGS. 1 and 2. FIG. 3 is described with reference to FIGS. 1 and 2.

The method 300 according to FIG. 3 includes: detecting 310 a connection of the second data processing device 261 and the first data processing device 250 by the trailer-specific network interface 252.

The method 300 includes: assigning 320 the trailer-specific zone 271 and/or the trailer-specific domain 276 to the second data processing device 261.

The method 300 includes: outputting and/or storing 330 an assignment information item ZI corresponding to the assignment 320.

A person skilled in the art recognizes that the method 300 according to FIG. 3 can also be carried out in a sequence other than that illustrated. In particular, it is possible that steps of the method 300 can be interchanged, shifted and/or carried out simultaneously.

FIG. 4 shows a schematic illustration of a computer program and/or computer-readable medium 400 according to an aspect of the disclosure. The computer program and/or computer-readable medium 400 includes commands (not shown) which, when the program or the commands is or are executed by a data processing device 250, cause the latter to carry out the method 300 and/or the steps of the method 300 according to FIG. 3.

The commands may be present as a program code in any desired code or in any desired language, in particular in a code that is suitable for motor vehicle controllers. The computer program and/or computer-readable medium 200 may be or include any desired digital data storage device, such as a USB stick, a hard disk, a CD-ROM, a DVD-ROM, an SD card or an SSD card. The computer program does not necessarily have to be stored on such a computer-readable storage medium, but may also be retrievable via the Internet or in some other way.

It is understood that the foregoing description is that of the preferred embodiments of the invention and that various changes and modifications may be made thereto without departing from the spirit and scope of the invention as defined in the appended claims.

Reference signs (part of the description)

| | |
|---|---|
| 200a | Vehicle |
| 200b | Utility vehicle |
| 205 | Tractor vehicle |
| 206 | Trailer vehicle |
| 240 | Network system |
| 250 | Tractor-vehicle-side first data processing device |
| 251 | Network interface |
| 252 | Trailer-specific network interface |
| 253 | Ethernet interface |
| 255 | Tractor vehicle-trailer vehicle interface |
| 260 | Further data processing device |
| 261 | Trailer-side second data processing device |
| 262 | Trailer-side further data processing device |
| 270 | Zone |
| 271, 271' | Trailer-specific zone |
| 275 | Domain |
| 276, 276' | Trailer-specific domain |
| 300 | Method |
| 310 | Detection |
| 320 | Assignment |
| 330 | Output and/or storage |
| 400 | Computer program and/or computer- |
| | readable medium |
| ZI | Assignment information item |

1. A network system for a tractor vehicle of a multi-unit vehicle having the tractor vehicle and a trailer vehicle, the network system comprising:
a tractor-vehicle-side first data processing device having a plurality of network interfaces, wherein each of said plurality of network interfaces is configured to communicatively connect said tractor-vehicle-side first data processing device to a further data processing device;
the network system being configured to assign at least one of a zone of the vehicle and a domain of the vehicle to each of said further data processing devices in accordance with a corresponding one of said plurality of network interfaces by which a particular one of said further data processing device is communicatively connected and/or connectable to said tractor-vehicle-side first data processing device;
one of said plurality of network interfaces being connected and/or connectable to a trailer-side second data processing device; and,
the network system being configured to assign at least one of a trailer-specific zone and a trailer-specific domain to said second data processing device.

2. The network system of claim 1, wherein said at least one of trailer-specific zone and trailer-specific domain is assignable to said second data processing device on a basis of the connection via a trailer-specific network interface.

3. The network system of claim 1, wherein each of said plurality of network interfaces is an Automotive Ethernet interface.

4. The network system of claim 1 further comprising a tractor vehicle-trailer vehicle interface connected to a trailer-specific network interface for communicatively connecting said first data processing device and said second data processing device.

5. The network system of claim 1, wherein each of said plurality of network interfaces is configured for wired communicative connection.

6. The network system of claim 1, wherein at least one of:
the vehicle has a plurality of zones and the trailer-specific zone differs from each of the plurality of zones; and,
the vehicle has a plurality of domains and said trailer-specific domain differs from each of the plurality of domains.

7. The network system of claim 1, wherein the network system is configured to assign at least one of a plurality of trailer-specific zones and a plurality of trailer-specific domains to trailer-side further data processing devices.

8. The network system of claim 1, wherein the multi-unit vehicle is a utility vehicle.

9. A tractor vehicle of a multi-unit vehicle, the tractor vehicle comprising:
a network system including a tractor-vehicle-side first data processing device having a plurality of network interfaces, wherein each of said plurality of network interfaces is configured to communicatively connect said tractor-vehicle-side first data processing device to a further data processing device;
said network system being configured to assign at least one of a zone of the multi-unit vehicle and a domain of the multi-unit vehicle to each of said further data processing devices in accordance with a corresponding one of said plurality of network interfaces by which a particular one of said further data processing device is communicatively connected and/or connectable to said tractor-vehicle-side first data processing device;
one of said plurality of network interfaces being connected and/or connectable to a trailer-side second data processing device; and,
said network system being configured to assign at least one of a trailer-specific zone and trailer-specific domain to said second data processing device.

10. The tractor vehicle of claim 9, wherein the multi-unit vehicle is a utility vehicle.

11. A method for establishing a network system including a tractor-vehicle-side first data processing device having a plurality of network interfaces, wherein each of said plurality of network interfaces is configured to communicatively connect the tractor-vehicle-side first data processing device to a further data processing device; the network system being configured to assign at least one of a zone of a vehicle and a domain of the vehicle to each of said further data processing devices in accordance with a corresponding one of the plurality of network interfaces by which a particular one of the further data processing devices is communicatively connected and/or connectable to the tractor-vehicle-side first data processing device; one of the plurality of network interfaces being connected and/or connectable to a trailer-side second data processing device; the method comprising:
detecting a connection of the trailer-side second data processing device and the tractor-vehicle-side first data processing device by a trailer-specific network interface of the plurality of network interfaces;
assigning at least one of a trailer-specific zone and a trailer-specific domain to the trailer-side second data processing device; and
at least one of outputting and storing an assignment information item corresponding to an assignment.

12. A computer program comprising commands which, when the program is executed by a data processing device, cause the data processing device to carry out the method of claim 11.

13. A computer-readable medium comprising commands which, when the commands are executed by a data processing device, cause the data processing device to carry out the method of claim 11.
